(19) United States
(12) Patent Application Publication
(10) Pub. No.: US 2023/0394765 A1
(43) Pub. Date: Dec. 7, 2023

(54) Generation of 3D Room Plans With 2D Shapes and 3D Primitives

(71) Applicant: Apple Inc., Cupertino, CA (US)

(72) Inventors: Feng Tang, Los Altos, CA (US); Kai Kang, Sunnyvale, CA (US); Yikang Liao, Sunnyvale, CA (US); Joerg A. Liebelt, Los Gatos, CA (US); Afshin Dehghan, San Francisco, CA (US); Yang Yang, Sunnyvale, CA (US); Fengfu Li, Beijing (CN); Hongyu Xu, San Jose, CA (US)

(21) Appl. No.: 18/202,357

(22) Filed: May 26, 2023

Related U.S. Application Data
(60) Provisional application No. 63/348,759, filed on Jun. 3, 2022.

(51) Int. Cl. G06T 17/20; G06T 7/73

(52) U.S. Cl. CPC G06T 17/20; G06T 7/73; G06T 2210/04; G06T 2200/08; G06T 2200/04

(57) ABSTRACT

Various implementations disclosed herein include devices, systems, and methods that provide a 3D room plan that combines 2D shapes representing elements of a room that are approximately planar (e.g., walls, wall openings, windows, doors, etc.) with 3D primitives representing non-planar elements (e.g., tables, chairs, appliances, etc.). A 3D room plan is a 3D representation of a room or other physical environment that generally identifies or otherwise represents 3D positions of one or more walls, floors, ceilings, other boundaries, other regions, windows, doors, openings, and 3D objects (e.g., objects having significant height, width, and depth in 3 dimensions) within the environment. For example, a 3D floor plan using 2D shapes to represent walls, windows, doors, etc. may be combined with 3D primitives such as 3D bounding boxes representing 3D objects to form a 3D room plan.

### CROSS-REFERENCE TO RELATED APPLICATIONS

This application claims the benefit of U.S. Provisional Application Ser. No. 63/348,759 filed Jun. 3, 2023, which is incorporated herein in its entirety.

### TECHNICAL FIELD

The present disclosure generally relates to electronic devices that use sensors to scan physical environments to generate three dimensional (3D) models such as 3D room plans.

### BACKGROUND

Existing scanning systems and techniques may be improved with respect to assessing and using the sensor data obtained during scanning processes to generate 3D representations such as 3D room plans representing physical environments.

### SUMMARY

Various implementations disclosed herein include devices, systems, and methods that provide a 3D room plan that combines 2D shapes representing elements of a room that are approximately planar (e.g., architectural elements such as walls, wall openings, windows, doors, etc.) with 3D primitives representing non-planar elements (e.g., tables, chairs, appliances, etc.). A 3D room plan is a 3D representation of a room or other physical environment that generally identifies or otherwise represents 3D positions of one or more walls, floors, ceilings, windows, doors, openings, and 3D objects (e.g., non-planar objects having significant height, width, and depth in 3 dimensions) within the environment. For example, a 3D floor plan using 2D shapes to represent walls, windows, doors, and other architectural elements of the room may be combined with 3D primitives such as 3D bounding boxes representing 3D objects within the physical environment to form a 3D room plan.

In some implementations, a processor performs a method by executing instructions stored on a computer readable medium. The method obtains sensor data of a room in a physical environment during a scan of the room. This may involve obtaining a 3D representation of the room based on sensor data. For example, this may involve generating a 3D point cloud or a 3D mesh based on image and/or depth sensor data capture within the physical environment from various positions and orientations, e.g., as the user moves around and scans the environment.

The method determines two-dimensional (2D) shapes (e.g., rectangles or other polygons, circles, ellipses, etc.) representing boundaries of the room based on the sensor data. The method may determine 3D positions for the 2D shapes. The 2D shapes may represent approximately planar features of the room. The 2D shapes may provide a 3D floor plan that defines the positions and sizes of walls, windows, doors, and other planar architectural elements by specifying parameters, e.g., parameters for a wall providing two opposing corner locations specifying the position and size of a rectangular region in a 3D coordinate system.

The method further involves determining a 3D primitive (e.g., bounding box, cone, cylinder, wedge, sphere, torus, pyramid, etc.) representing a 3D object in the room based on the sensor data. The method may determine 3D position for 3D primitive representing the 3D object in the room based on the sensor data. Such a 3D primitive may be specified using primitive parameters that specify opposing corners of the primitive or sufficient vertices of the 3D primitive sufficient to specify its position and size in the coordinate space.

The method generates a 3D representation of the room by combining the 2D shapes to form at least a portion of the boundaries of the room and positioning the 3D primitive within the at least a portion of the boundaries of the room. The 2D shapes and 3D primitives may be combined in a single model based on the 3D positions for the 2D shapes and the 3D position for the 3D primitive.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an electronic device in a physical environment in accordance with some implementations.

FIG. 2 illustrates a portion of a 3D point cloud representing the room of FIG. 1 in accordance with some implementations.

FIG. 3 illustrates a portion of a 3D floor plan representing a room of FIG. 1, in accordance with some implementations.

FIG. 4 is a view of the 3D floor plan of FIG. 3.

FIG. 5 is another view of the 3D floor plan of FIGS. 3 and 4.

FIG. 6 is flow chart illustrating an exemplary 3D room plan generation pipeline in accordance with some implementations.

FIG. 7 illustrates element definitions for an exemplary 3D floor plan in accordance with some implementations.

FIG. 8 is a flowchart illustrating a method for generating a 3D room plan in accordance with some implementations.

FIG. 9 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

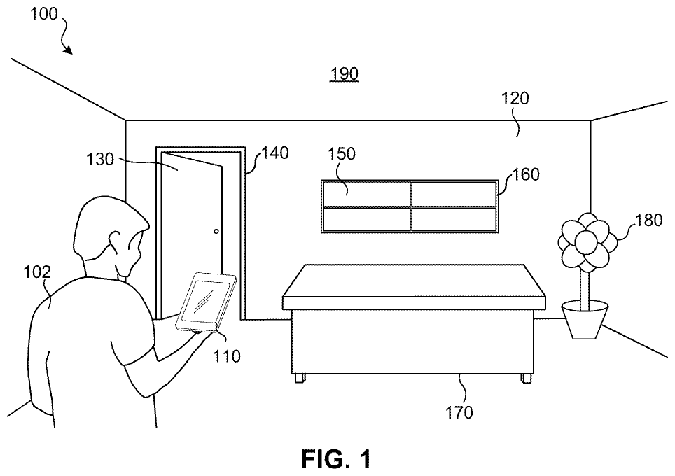

FIG. 1 illustrates an exemplary physical environment 100. FIG. 1 illustrates an exemplary electronic device 110 operating in a room of the physical environment 100. In this example, the room includes a door 130 providing an opening leading to a second room of the physical environment 100 which may or may not also be included in the 3D room plan. The room also includes a door frame 140, a window 150 (with window frame 160) on wall 120, a desk 170 and a potted plant 180.

The electronic device 110 includes one or more cameras, microphones, depth sensors, motion sensors, or other sensors that can be used to capture information about and evaluate the physical environment 100. The obtained sensor data may be used to generate a 3D representation, such as a 3D point cloud, a 3D mesh, a 3D floor plan, and/or a 3D room plan.

In one example, the user 102 moves around the physical environment 100 and the device 110 captures sensor data from which one or more 3D room plans of the physical environment 100 are generated. The device 110 may be moved to capture sensor data from different viewpoints, e.g., at various distances, viewing angles, heights, etc. The device 110 may provide information to the user 102 that facilitates the scanning process. For example, the device 110 may provide a view from a camera feed showing the content of RGB images currently being captured, e.g., a live camera feed, during the scanning process. As another example, the device 110 may provide a view of a live generated 3D point cloud, a live generated 3D floor plan, or a live generated 3D room plan to facilitate the scanning process or otherwise provide feedback that informs the user 102 of which portions of the physical environment 100 have already been captured in sensor data and which portions of the physical environment 100 require more sensor data in order to be represented accurately in a 3D representation, 3D floor plan, and/or 3D room plan.

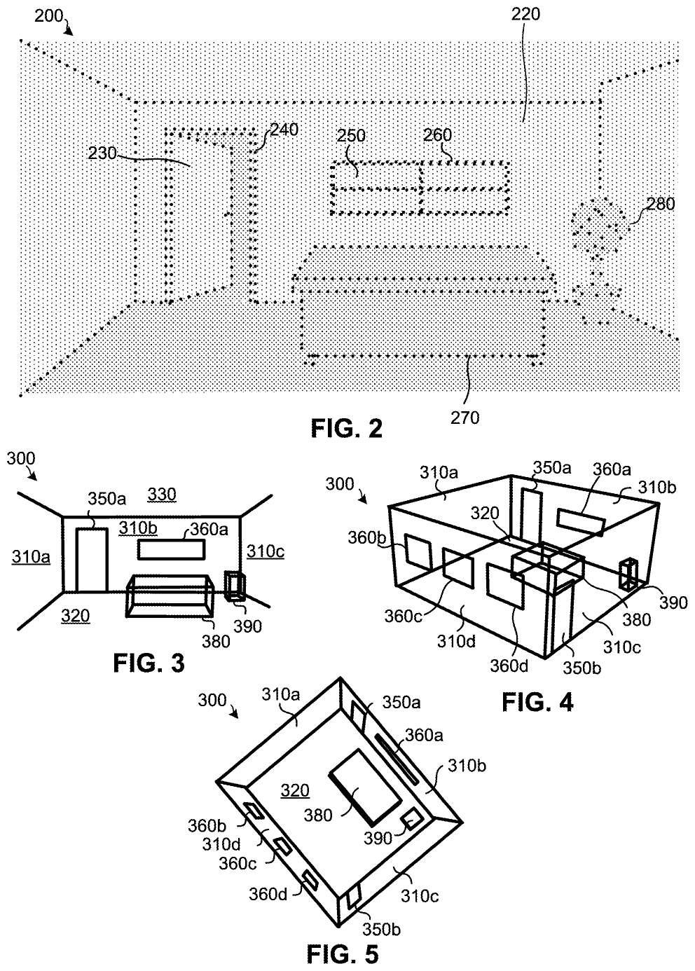

The device 110 performs a scan of the room to capture data from which a 3D room plan 300 (FIG. 3-5) of the room is generated. In this process, for example, a dense point-based representation, such as a 3D point cloud 200 (FIG. 2), may be generated to represent the room and used to generate the 3D room plan 300, which may include a (a) 3D floor plan represent the 3D positions of the walls, wall openings, windows, doors, and (b) representations of 3D objects of the room. In some implementations, a 3D room plan defines the positions of such elements using non-point cloud data/non-mesh data, for example, using one or more parametric representations. For example, such a parametric representation may define 2D shapes and 3D primitives that represent the positions and sizes of elements of a room in the 3D room plan. In some implementations, a 3D room plan of a room is generated based on a 3D point cloud that is generated during a scan of the room, e.g., a scan captured as user 102 walks around the room capturing sensor data.

FIG. 2 illustrates a portion of a 3D point cloud representing the room of FIG. 1. In some implementations, the 3D point cloud 200 is generated based on one or more images (e.g., greyscale, RGB, etc.), one or more depth images, and motion data regarding movement of the device in between different image captures. In some implementations, an initial 3D point cloud is generated based on sensor data and then the initial 3D point cloud is densified via an algorithm, machine learning model, or other process that adds additional points to the 3D point cloud. The 3D point cloud 200 may include information identifying 3D coordinates of points in a 3D coordinate system. Each of the points may be associated with characteristic information, e.g., identifying a color of the point based on the color of the corresponding portion of an object or surface in the physical environment 100, a surface normal direction based on the surface normal direction of the corresponding portion of the object or surface in the physical environment 100, a semantic label identifying the type of object with which the point is associated, etc.

In alternative implementations, a 3D mesh is generated in which points of the 3D mesh have 3D coordinates such that groups of the mesh points identify surface portions, e.g., triangles, corresponding to surfaces of the room of the physical environment 100. Such points and/or associated mesh shapes (e.g., triangles) may be associated with color, surface normal directions, and/or semantic labels.

In the example of FIG. 2, the 3D point cloud 200 includes a set of points 220 representing wall 120, a set of points 230 representing door 130, a set of points 240 representing the door frame 240, a set of points 250 representing the window 150, a set of points 260 representing the window frame 160, a set of points 270 representing the desk 170, and a set of points 280 representing the potted plant 180. In this example, the points of the 3D point cloud 200 are depicted with relative uniformity and with points on object edges emphasized to facilitate easier understanding of the figures. However, it should be understood that the 3D point cloud 200 need not include uniformly distributed points and need not include points representing object edges that are emphasized or otherwise different than other points of the 3D point cloud 200.

The 3D point cloud 200 may be used to identify one or more boundaries and/or regions (e.g., walls, floors, ceilings, etc.) within the room of the physical environment 100. The relative positions of these surfaces may be determined relative to the physical environment 100 and/or the 3D point-based representation 200. In some implementations, a plane detection algorithm, machine learning model, or other technique is performed using sensor data and/or a 3D point-based representation (such as 3D point cloud 200). The plane detection algorithm may detect the 3D positions in a 3D coordinate system of one or more planes of physical environment 100. The detected planes may be defined by one or more boundaries, corners, or other 3D spatial parameters. The detected planes may be associated with one or more types of features, e.g., wall, ceiling, floor, table-top, counter-top, cabinet front, etc., and/or may be semantically labelled. Detected planes associated with certain features (e.g., walls, floors, ceilings, etc.) may be analyzed with respect to whether such planes include windows, doors, and openings. Similarly, the 3D point cloud 200 may be used to identify one or more boundaries or bounding boxes around one or more objects, e.g., bounding boxes corresponding to table 170 and plant 180.

The 3D point cloud 200 is used to generate room plan 300 (as illustrated in FIGS. 3-5) representing one or more rooms of the physical environment 100 of FIG. 1. For example, detected planes, boundaries, bounding boxes, etc. may be detected and used to generate shapes, e.g., 2D shapes and/or 3D primitives that parametrically represent the elements of the room of the physical environment 100. In FIGS. 3-5, wall representations 310a-d represent the walls of the room (e.g., wall representation 310b represents wall 120), floor representation 320 represents the floor of the room, door representations 350a-b represent the doors of the room (e.g., door representation 350a represents door 130), window representations 360a-d represent the windows of the room (e.g., window representation 360a represents window 150), desk representation 380 is a bounding box representing desk 170, and flowers representation 290 is a bounding box representing flowers 180. A bounding box representation may have 3D dimensions that correspond to the dimensions of the object itself, providing a simplified yet scaled representation of the object. In this example, the 3D room plan 300 includes object representations for non-room-boundaries, e.g., for 3D objects within the room such as desk 170 and flowers 180, and thus represents more than just the approximately planar, architectural floor plan elements. In other implementations, a 3D room plan is simply a 3D floor plan, representing only planar, architectural floor plan element, e.g., walls, floor, doors, windows, etc.

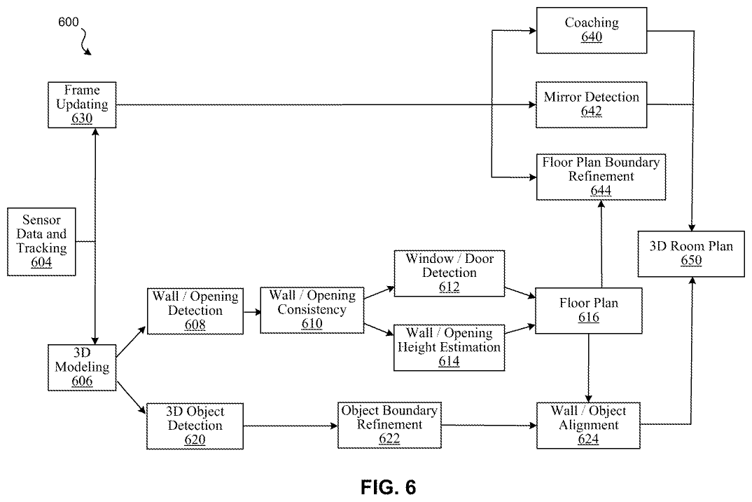

FIG. 6 is flow chart illustrating an exemplary 3D room plan generation pipeline 600, which may be executed at a device such as device 110 of FIG. 1. In this pipeline 600, sensor data is obtained at sensor data and tracking block 604. Such sensor data may include captured images, depth sensor data, ambient light sensor data, motion sensor data and/or any other type of sensor data useful in scanning, providing, feedback, and/or 3D room scan generation. At sensor data and tracking block 604, the device may track its pose (i.e., position and/or orientation) as the device captures the sensor data. Data from the sensor data and tracking block 604 is used at 3D modeling block 606.

The 3D modeling block 606 may use the sensor data (e.g., during the scanning of the physical environment) to generate and update a 3D model (e.g., a 3D point cloud or 3D mesh) representing the physical environment. As more and more sensor data is received and processed, the 3D model may be refined and updated. Such updating may occur live during the scanning process and/or after the scanning process concludes. The 3D modeling block 606 may provide a 3D model that comprises points or mesh polygons that correspond to surface portions of the physical environment. Such points and/or mesh polygons may each have a 3D position and be associated with additional information including, but not limited to, color information, surface normal information, and semantic label information, e.g., identifying the type of object each point or mesh polygon corresponds. The color, surface normal, and semantic information may be determined based on evaluating the sensor data, for example, using an algorithm or machine learning model. The 3D modeling block 606 may provide a 3D model to the wall/opening detection block 608 and/or to the 3D object detection block 610. The 3D model that is provided to these blocks 608, 610 may be updated over time, e.g., during the capturing of sensor data during scanning process and/or after the scanning process.

The wall/opening detection block 608 uses the 3D model to detect walls and openings within the physical environment. This may involve predicting planar surfaces corresponding to walls, floors, ceilings, etc. and/or boundaries of such planar surfaces. In some implementations, a machine learning model evaluates the 3D model and/or sensor data to identify planar surfaces and/or to detect the walls, openings, etc. This may involve using positional and additional information associated with points/mesh polygons of the 3D model. For example, this may involve using the positions, colors, surface normal, and/or semantics associated with the points/mesh polygons of the 3D point cloud or 3D mesh.

The wall/opening consistency block 610 uses the detected walls, openings, etc. and compares them with other data to ensure that the positioning, sizes, shapes, etc. of the walls, openings, etc. are consistent with one another. The wall/opening consistency block 610 provides the adjusted walls, openings, etc. to the window/door detection block 612 and the wall/opening height estimation block 614.

The window/door detection block 612 detects windows and doors on the walls. Such detection may utilize the 3D model from block 606, sensor data from block 604, and/or data about the walls, openings, etc. from block 610. In some implementations, the window/door detection block 612 detects points/mesh polygons of the 3D model that are within a threshold distance of a detected wall, opening, etc. and associates those points/mesh polygon vertices with the wall. For example, this may involve projecting some point cloud points onto the plane of the wall. Windows, doors, etc. may be detected based on the projected points with or without semantic information. In some implementations, an algorithm or machine learning model interprets the 3D model and detected walls, openings, etc. to predict the locations and sizes of windows, doors, etc.

The wall/opening height estimation block 614 estimates the heights of walls and openings. Such detection may utilize the 3D model from block 606, sensor data from block 604, and/or data about the walls, openings, etc. from block 610. Such detection may include the use of an algorithm or machine learning model.

The output of blocks 612, 614 is used to produce a 3D floor plan at block 616 that specifies the locations and sizes of elements of the physical environment that are approximately planar/architectural, e.g., walls, floors, ceilings, openings, windows, doors, etc. Such a 3D floor plan may represent the planar elements of the physical environment parametrically, e.g., by specifying positions of two or more points that provide sufficient information to form a rectangle, polygon, or other 2D shape, e.g., opposing corner points defining a rectangles shape and position within a 3D coordinate system. In some implementations, approximately planar/architectural, e.g., walls, floors, ceilings, openings, windows, doors, etc. have some thickness and are represented, for example, using parameters that specify a 2D shape and a thickness.

The 3D model from block 606 is also output to 3D object detection block 620. The 3D object detection block 620 may detect objects such as tables, televisions, screens, refrigerators, fireplaces, shelves, ovens, chairs, stairs, sofas, dishwashers, cabinets, stoves, beds, toilets, washers, dryers, sinks, bathtubs, etc. Such detection may utilize the 3D model from block 606 and/or sensor data from block 604. Such detection may include the use of an algorithm or machine learning model. In some implementations, a machine learning model evaluates the 3D model and/or sensor data to identify bounding boxes or other primitive shapes around 3D objects. This may involve using positional and additional information associated with points/mesh polygons of the 3D model. For example, this may involve using the positions, colors, surface normal, and/or semantics associated with the points/mesh polygons of the 3D point cloud or 3D mesh. As a specific example, a group of points corresponding to a table type object may be identified based on the semantic labels associated with the points of a point cloud. A bounding box around these points may be determined based on the location of the points. Such a bounding box may be oriented based on surface normal of the points, e.g., so that the bounding box orientation matches the orientation of the table.

At the object boundary refinement block 622 the boundaries of 3D objects detected at block 620 are refined. Such refinement may utilize the 3D model from block 606, sensor data from block 604, the 3D objects detected at block 620. The sensor data from block 604 may include frame updates from block 630, e.g., sensor data associated images that are used to provide a live preview during the scan, semantically-labeled images, etc. Such refinements may be used by coaching block 640 or otherwise to provide feedback to the user by adjusting the locations of object representations (e.g., bounding box edges) that may not line up precisely with corresponding real-world edges depicted in live image data. Thus, in some implementations, the refinements may be used to display edge indications over a live view during the scan. In some implementations, such refinements are used only for live view augmentation during scanning. In some implementations, such refinements are used only to improve the 3D object representations for use in generating the 3D room plan. In some implementations, such refinements are used for both. The unrefined and/or refined 3D objects may be provided to wall/object alignment block 624.

The wall/object alignment block 624 adjusts the 3D object representations (e.g., the 3D bounding box representations) based on floor plan 616. For example, a 3D bounding box for table located close to a wall may be adjusted to be parallel to the wall, against the wall, etc. In some implementations, 3D objects representations that are withing a threshold distance of a wall of the floor plan 616 are automatically adjusted to be aligned with the wall.

The output of wall/object alignment block 624 provides bounding boxes or other 3D primitive representations of 3D objects for use in generating the 3D room plan 650.

The 3D primitive representation may represent a 3D object parametrically, e.g., by specifying positions of two or more vertices that provide sufficient information to form a 3D box, cone, cylinder, wedge, sphere, torus, pyramid, etc., e.g., opposing corner points defining a 3D box's shape and position within a 3D coordinate system.

The sensor data and tracking block 604 also provides data used by frame updating block 630. Frame updating block 630 includes 2D frame data captured in the physical environment during the scan. It may include frame-based data (e.g., 2D images, 2D depth images, semantically-labelled 2D image, etc.) that is captured at a relatively fast rate during the scan. The frame data may be updated at a rate that is faster than the updating of the 3D model at 3D modeling block 606. Frame updating block 630 provides 2D frame data to the coaching block 640, mirror detection block 642, and floor plan boundary refinement block 644.

Coaching block 640 may provide guidance or other information during the scanning process to facilitate the scanning process. For example, it may provide a live view of image data being captured, e.g., via pass through video, identify how the user should move the device to capture data for yet-to-be captured portions of the physical environment, guide the user to take actions to improve the quality of the image capture, e.g., to move more slowly, rescan an area, move to scan a new area, increase ambient lighting, etc.

Mirror detection block 642 uses the 2D frame data from frame updating block 630 to detect mirrors in the physical environment. Mirror detection may involve an algorithm or machine learning process configured to detect reflective surfaces within the physical environment. The mirror detection block 642 may provide information about detected mirror that is used to generate the 3D room plan 650.

The floor plan boundary refinement block 644 uses the 2D frame data from frame updating block 630 and the floor plan 616 to determine refinements to the floor plan. Such refinements may be used by coaching block 640 or otherwise to provide feedback to the user about the locations of wall edges and other boundaries determined for the floor plan 616 that may not line up precisely with corresponding real-world edges depicted in live image data. Thus, in some implementations, the refinements of the floor plan may be used to display edge indications over a live view during the scan. The floor plan boundary refinement may involve using 2D RGB images, 2D semantically-labelled images, 2D depth data or other 2D data obtained or generated therefrom to determine adjustments to boundaries of walls, openings, windows, doors, etc. in the floor plan. In some implementations, such refinements are used only for providing augmentations to a live view during scanning. In some implementations, such refinements are used only to improve the floor plan 616 that is used to generate the 3D room plan 650. In some implementations, such refinements are used to both provide live augmentations to a live view and to improve the floor plan 616.

The 3D room plan 650 thus combines a floor plan 616 having 2D shapes representing walls, openings, doors, windows, and other planar/architectural elements with 3D object representations from block 624. It may additionally account for information from coaching block 640 and mirror detection 642. The resulting 3D room plan 650 may be generated efficiently and accurately due to the relatively high-level/parametric representations. In some implementations, the 3D room plan 650 is generated relatively quickly, e.g., during or shortly after the scanning of the physical environment and does not require significant waiting (e.g., minutes, hours, days, etc.) for significant manual modification or other post-processing procedures.

The use of parametric representations to define a 3D room plan 350 may enable defining the 3D room plan 350 using a simple, compact data set that can be efficiently stored, managed, rendered, modified, shared, transmitted, or otherwise used. Such a 3D room plan may provide significant advantages over a non-parametrically-defined 3D room plan such as a room plan utilize dense point clouds or 3D meshes having hundreds or thousands of vertices representing hundreds or thousands of triangular faces. A parametric representation may utilize 3D bounding shapes that are primitives to represent the shapes of tables, objects, appliances, etc. Such representations may significantly simplify details while still providing a 3D room plan that accurately models significant aspects of the room.

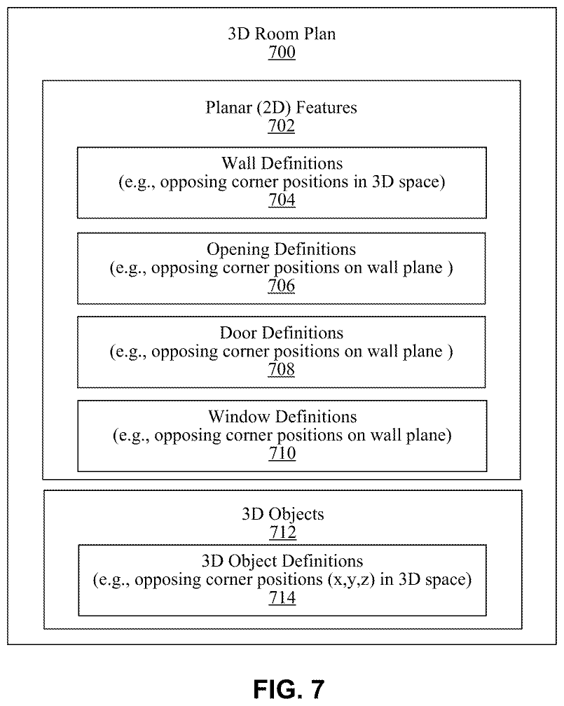

FIG. 7 illustrates element definitions for an exemplary 3D floor plan 700. In this example, the 3D room plan 700 includes wall definitions 704, e.g., specifying opposing corners of a 2D rectangular region corresponding to a wall in a 3D coordinate system. For example, a wall may be specified by a point at x, y, z position 0, 0, 0 and a point at x, y, z position 10, 0, 10. These two points together define a position of a four-sided rectangular shape in 3D space, e.g., a rectangle having an edge from 0, 0, 0 to 0, 0, 10, an edge from 0, 0, 10 to 10, 0, 10, an edge from 10, 0, 10 to 10, 0, 0, and an edge from 10, 0, 0 to 0, 0, 0.

The 3D room plan 700 further includes opening definitions 706, e.g., specifying opposing corners of a 2D rectangular region corresponding to an opening on a wall in a 2D coordinate system of the wall. For example, an opening may be specified as a rectangle on wall W1 from x, y point 2, 2 to x, y point 3, 3. Note that the wall's 2D coordinate system may be different than the 3D coordinate system in which the wall's position is itself defined. However, since the wall's own position in the 3D coordinate system is known, the positioning of elements defined relative to the wall's own coordinate system may be used to position those objects relative to the 3D coordinate system Similarly, the 3D room plan 700 further includes door definitions 708, e.g., specifying opposing corners of a 2D rectangular region corresponding to a door, and window definitions 710, e.g., specifying opposing corners of a 2D rectangular region corresponding to a window.

The 3D room plan 700 may also include non-planar elements including 3D objects 712. For example, a wall may be specified by a point at x, y, z position 4, 4, 0 and a point at x, y, z position 6, 6, 2. These two points define a position of a six-sided bounding box in 3D space. The 3D objects 712 and planar features 702 may be defined with respect to the same 3D coordinate space.

In some implementations, a 3D room plan rendering engine is configured to interpret a parametric representation of a 3D room plan 700 to provide a view of the 3D room plan 700. The room may provide a top-down perspective view (e.g., a bird's eye view as illustrated in FIG. 5). In some implementations, a user interface provides a view of such a 3D room plan 700 and receives input modifying the 3D room plan 700, e.g., repositioning a 3D bounding box representing a table or making the 3D room plan 700 larger by moving a wall out 5 feet. The graphical user interface may additionally or alternatively provide a view of CAD, voxel, and/or mesh representation of the 3D object. The changes to a graphical depiction of a 3D floor plan 700 on a graphical user interface (or other user interface) may be interpreted to adjust the parametric representation of the 3D room plan, e.g., a bounding box's points that define its position and size may be changed based on a change to the position or size of the bounding box on the user interface.

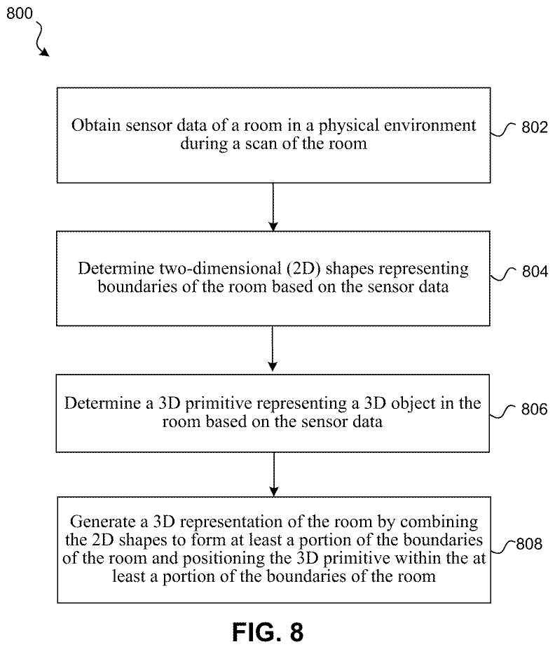

FIG. 8 is a flowchart illustrating a process 800 for generating a 3D room plan. In some implementations, a device such as electronic device 110 performs method 800. In some implementations, method 800 is performed on a mobile device, desktop, laptop, HMD, or server device. The method 800 is performed by processing logic, including hardware, firmware, software, or a combination thereof. In some implementations, the method 800 is performed on a processor executing code stored in a non-transitory computer-readable medium (e.g., a memory).

At block 802, the method 800 obtains sensor data of a room in a physical environment during a scan of the room. The method 800 may obtain a 3D representation of the room based on the sensor data. In some implementations, the sensor data comprises image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, etc.). In some implementations, the sensor data includes visual inertial odometry (VIO) data determined based on image data. The 3D representation may be a 3D model such as a 3D point cloud or 3D mesh providing information about the positions and appearance of surface portions within the physical environment. In some implementations, the 3D representation is obtained over time, e.g., during a scan, the 3D representation may be updated, and updated versions of the 3D representation obtained over time. For example, a 3D point cloud may be obtained (and analyzed/processed) as it is updated over time.

At block 804, the method 800 determines 2D shapes (e.g., rectangles or other polygons, circles, ellipses, etc.) representing boundaries of the room based on the sensor data. The method 800 may determine 3D positions for the 2D shapes based on the sensor data. Each of the 2D shapes may be defined by parameters specifying a plurality of points that define a position and a size of a respective 2D polygon in a 3D coordinate system.

This determining (at block 804) may involve generating a floor plan (e.g., floor plan 616 of FIG. 6) that defines the positions and sizes of walls, windows, doors, etc. The floor plan may specify parameters, such as parameter's specifying the position of wall by specifying two opposing corner locations that specify the position and size of a rectangular region in a 3D coordinate system. Determining the 3D positions for the 2D shapes may involve detecting walls and wall openings based on the 3D representation of the room (e.g., as illustrated in block 608 of FIG. 6). Determining the 3D positions for the 2D shapes may involve performing a wall opening consistency process (e.g., as illustrated in block 610 of FIG. 6). Determining the 3D positions for the 2D shapes may involve detecting windows or doors on walls of the room (e.g., as illustrated in block 612 of FIG. 6). Determining the 3D positions for the 2D shapes may involve estimating a wall or a wall opening height based on the 3D representation (e.g., as illustrated in block 614 of FIG. 6). Determining the 3D positions for the 2D shapes may involve producing a floor plan based on the walls, wall openings, windows, doors, wall heights, and wall opening heights. Such a floor plan may be produced during (i.e., at or before the end of the scan). Determining the 3D positions for the 2D shapes may involve refining edge positions of the 2D shapes based on sensor data captured during the scan (e.g., as illustrated in block 644 of FIG. 6).

At block 806, the method 800 determines a 3D primitive (e.g., bounding box, cone, cylinder, wedge, sphere, torus, pyramid, etc.) representing a 3D object in the room based on the sensor data. The method 800 may determine 3D positions for one or more 3D primitives (e.g., bounding boxes, cones, cylinders, wedges, spheres, torus, pyramids, etc.) representing one or more 3D objects in the room based on the sensor data. Each of the 3D primitives may be defined by parameters specifying a plurality of points that define a position and a size of a respective primitive in a 3D coordinate system. This determining (at block 806) may involve determining primitive parameters that specify opposing corners of the 3D primitive or sufficient vertices of the 3D primitive sufficient to specify its position and size in the 3D coordinate space.

Determining 3D positions for the one or more 3D primitives may involve detecting the one or more 3D objects based on the 3D representation (e.g., as illustrated in block 620 of FIG. 6). Determining 3D positions for the one or more 3D primitives may involve refining object boundaries based on sensor data captured during the scan (e.g., as illustrated in block 622 of FIG. 6). Determining 3D positions for the one or more 3D primitives may involve aligning at least one of the one or more 3D primitive with at least one of the 2D shapes (e.g., as illustrated in block 624 of FIG. 6). Determining 3D positions for the one or more 3D primitives may involve producing data specifying the positions of the one or more 3D primitives.

At block 808, the method generates a 3D representation of the room by combining the 2D shapes to form at least a portion of the boundaries of the room and positioning the 3D primitive within the at least a portion of the boundaries of the room. Generating the 3D representation of the room may involve combining the 2D shapes and the 3D primitive based on the 3D positions for the 2D shapes and the 3D position for the 3D primitive.

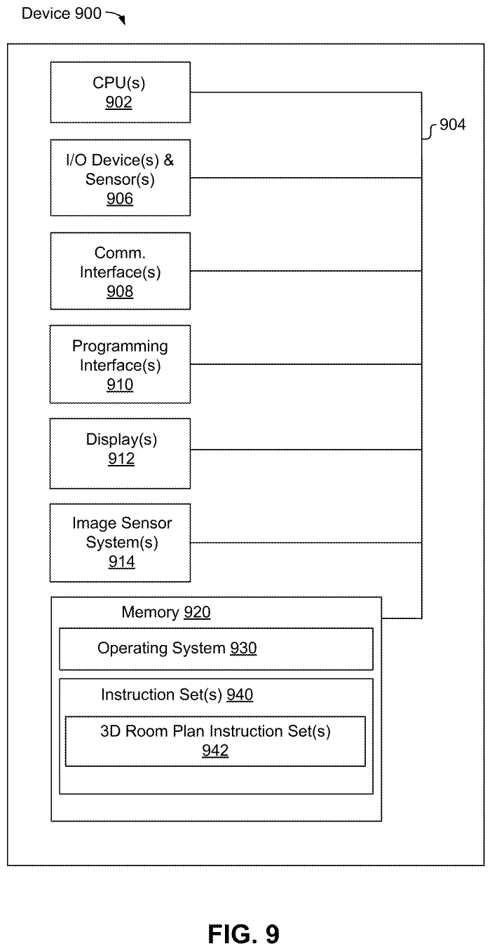

FIG. 9 is a block diagram of electronic device 900. Device 900 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 900 includes one or more processing units 902 (e.g., microprocessors, ASICs, FPGAs, GPUs, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 910, one or more output device(s) 912, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 912 include one or more displays configured to present a view of a 3D environment to the user. In some implementations, the one or more displays 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 900 includes a single display. In another example, the device 900 includes a display for each eye of the user.

In some implementations, the one or more output device(s) 912 include one or more audio producing devices. In some implementations, the one or more output device(s) 912 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. The one or more output device(s) 912 may additionally or alternatively be configured to generate haptics.

In some implementations, the one or more image sensor systems 914 are configured to obtain image data that corresponds to at least a portion of a physical environment. For example, the one or more image sensor systems 914 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 914 further include illumination sources that emit light, such as a flash. In various implementations, the one or more image sensor systems 914 further include an on-camera image signal processor (ISP) configured to execute a plurality of processing operations on the image data.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 comprises a non-transitory computer readable storage medium.

In some implementations, the memory 920 or the non-transitory computer readable storage medium of the memory 920 stores an optional operating system 930 and one or more instruction set(s) 940. The operating system 930 includes procedures for handling various basic system services and for performing hardware dependent tasks. In some implementations, the instruction set(s) 940 include executable software defined by binary information stored in the form of electrical charge. In some implementations, the instruction set(s) 940 are software that is executable by the one or more processing units 902 to carry out one or more of the techniques described herein.

The instruction set(s) 940 include a 3D room plan instruction set 942 configured to, upon execution, obtain sensor data, provide views/representations, select sets of sensor data, and/or generate 3D point clouds, 3D meshes, 3D floor plans, 3D room plans, and/or other 3D representations of physical environments as described herein. The instruction set(s) 940 may be embodied as a single software executable or multiple software executables.

Although the instruction set(s) 940 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor:
obtaining sensor data of a room in a physical environment during a scan of the room;
determining two-dimensional (2D) shapes representing boundaries of the room based on the sensor data;
determining a 3D primitive representing a 3D object in the room based on the sensor data; and
generating a 3D representation of the room by combining the 2D shapes to form at least a portion of the boundaries of the room and positioning the 3D primitive within the at least a portion of the boundaries of the room.

2. The method of claim 1, wherein each of the 2D shapes is defined by parameters specifying a plurality of points that define a position and a size of a respective 2D polygon in a 3D coordinate system.

3. The method of claim 1, wherein the 3D primitive is defined by parameters specifying a plurality of points that define a position and a size of the 3D primitive in a 3D coordinate system.

4. The method of claim 1, wherein determining the 2D shapes comprises:
detecting walls and wall openings based on the 3D representation of the room;
performing a wall opening consistency process;
detecting windows or doors on walls of the room; or
estimating a wall or a wall opening height based on the 3D representation.

5. The method of claim 1, wherein determining the 2D shapes comprises:
detecting walls and wall openings based on the 3D representation of the room;
performing a wall opening consistency process during the scan;
detecting windows or doors on walls of the room;
estimating a wall or a wall opening height based on the 3D representation; and
producing a floor plan based on the walls, wall openings, windows, doors, wall heights, and wall opening heights.

6. The method of claim 5, wherein the floor plan is produced during the scan.

7. The method of claim 1, wherein determining the 2D shapes comprises refining edge positions of the 2D shapes based on sensor data.

8. The method of claim 1, wherein determining the 3D primitive comprises:
detecting the 3D object based on the sensor data;
refining object boundaries based on the sensor data; or
aligning the 3D primitive with at least one of the 2D shapes.

9. The method of claim 1, wherein determining the 3D primitive comprises:
detecting the 3D object based on the sensor data;
refining object boundaries based on the sensor data; and
aligning the 3D primitive with at least one of the 2D shapes; and
producing data specifying the position of the 3D primitive.

10. The method of claim 1, wherein generating the 3D representation of the room is further based on detecting a mirror in the room.

11. The method of claim 1, wherein obtaining the sensor data comprises obtaining a three-dimensional (3D) representation of the room based on the sensor data.

12. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining sensor data of a room in a physical environment during a scan of the room;
determining two-dimensional (2D) shapes representing boundaries of the room based on the sensor data;
determining a 3D primitive representing a 3D object in the room based on the sensor data; and
generating a 3D representation of the room by combining the 2D shapes to form at least a portion of the boundaries of the room and positioning the 3D primitive within the at least a portion of the boundaries of the room.

13. The system of claim 12, wherein each of the 2D shapes is defined by parameters specifying a plurality of points that define a position and a size of a respective 2D polygon in a 3D coordinate system.

14. The system of claim 12, wherein the 3D primitive is defined by parameters specifying a plurality of points that define a position and a size of the 3D primitive in a 3D coordinate system.

15. The system of claim 12, wherein determining the 2D shapes comprises:
detecting walls and wall openings based on the 3D representation of the room;
performing a wall opening consistency process,
detecting windows or doors on walls of the room; or
estimating a wall or a wall opening height based on the 3D representation.

16. The system of claim 12, wherein determining the 2D shapes comprises:
detecting walls and wall openings based on the 3D representation of the room;
performing a wall opening consistency process during the scan;
detecting windows or doors on walls of the room;
estimating a wall or a wall opening height based on the 3D representation; and
producing a floor plan based on the walls, wall openings, windows, doors, wall heights, and wall opening heights.

17. The system of claim 16, wherein the floor plan is produced during the scan.

18. The system of claim 12, wherein determining the 2D shapes comprises:
refining edge positions of the 2D shapes based on sensor data;
detecting the 3D object based on the sensor data;
refining object boundaries based on the sensor data; or
aligning the 3D primitive with at least one of the 2D shapes.

19. The system of claim 12, wherein determining the 3D primitive comprises:
detecting the 3D object based on the sensor data;
refining object boundaries based on the sensor data; and
aligning the 3D primitive with at least one of the 2D shapes; and
producing data specifying the position of the 3D primitive.

20. A non-transitory computer-readable storage medium storing program instructions executable via one or more processors to perform operations comprising:
obtaining sensor data of a room in a physical environment during a scan of the room;
determining two-dimensional (2D) shapes representing boundaries of the room based on the sensor data;
determining a 3D primitive representing a 3D object in the room based on the sensor data; and
generating a 3D representation of the room by combining the 2D shapes to form at least a portion of the boundaries of the room and positioning the 3D primitive within the at least a portion of the boundaries of the room.
